(19) United States
(12) Patent Application Publication
(10) Pub. No.: US 2006/0175980 A1
(43) Pub. Date: Aug. 10, 2006

(54) Lamp with built-in voltage converter including a bidirectional thyristor diode (SIDAC)

(75) Inventors: Matthew B. Ballenger, Lexington, KY (US); Ernest C. Weyhrauch, Cookeville, TN (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/051,575

(22) Filed: Feb. 4, 2005

(51) Int. Cl. H05B 41/24

(52) U.S. Cl. 315/247

(57) ABSTRACT

A lamp includes a voltage conversion circuit that converts a line voltage at a lamp terminal to a load voltage usable by a light emitting element of the lamp. The voltage conversion circuit is housed entirely within a base of the lamp and includes a silicon diode for alternating current (SIDAC) that is connected in series between the lamp terminal and the light emitting element and that operates as a bilateral voltage triggered switch to clip the load voltage.

### BACKGROUND OF THE INVENTION

The present invention is directed to a lamp with a built-in voltage converter that converts line voltage to a voltage suitable for lamp operation.

Some lamps operate at a voltage lower than a line (or mains) voltage of, for example, 120V or 220V, and for such lamps a voltage converter that converts line voltage to a lower operating voltage must be provided. The voltage converter may be provided in a fixture to which the lamp is connected or within the lamp itself. U.S. Pat. No. 3,869,631 is an example of the latter, in which a diode is provided in an extended stem between the lamp screw base and stem press of the lamp for clipping the line voltage to reduce RMS load voltage at the light emitting element. U.S. Pat. No. 6,445,133 is another example of the latter, in which a voltage conversion circuit for reducing the load voltage at the light emitting element is divided with a high temperature tolerant part in the lamp base and a high temperature intolerant part in a lower temperature part of the lamp spaced from the high temperature tolerant part.

Factors to be considered when designing a voltage converter that is to be located within a lamp include the sizes of the lamp and voltage converter, costs of materials and production, production of a potentially harmful DC load on a source of power for installations of multiple lamps, and the operating temperature of the lamp and an effect of the operating temperature on a structure and operation of the voltage converter.

### SUMMARY OF THE INVENTION

An object of the present invention is to provide a novel lamp with a built-in voltage converter that includes a silicon diode for alternating current (SIDAC), which is a bidirectional thyristor diode.

A further object is to provide a lamp with a voltage conversion circuit that converts a line voltage at a lamp terminal to a load voltage usable by a light emitting element of the lamp, where the voltage conversion circuit is housed entirely within a base of the lamp and includes a SIDAC that is connected in series between the lamp terminal and the light emitting element and that operates as a bilateral voltage triggered switch to clip the load voltage.

A yet further object is to provide a lamp with this voltage conversion circuit that also includes a radio frequency interference (RFI) filter.

### BRIEF DESCRIPTION OF THE DRAWINGS

FIG. 1 is a partial cross section of an embodiment of a lamp of the present invention.

FIG. 2 is a graph depicting idealized characteristics of a prior art SIDAC.

FIG. 3 is a schematic circuit diagram of a prior art connection of a SIDAC to a lamp.

FIG. 4 is a schematic circuit diagram of an embodiment with a prior art RFI filter.

### DESCRIPTION OF PREFERRED EMBODIMENTS

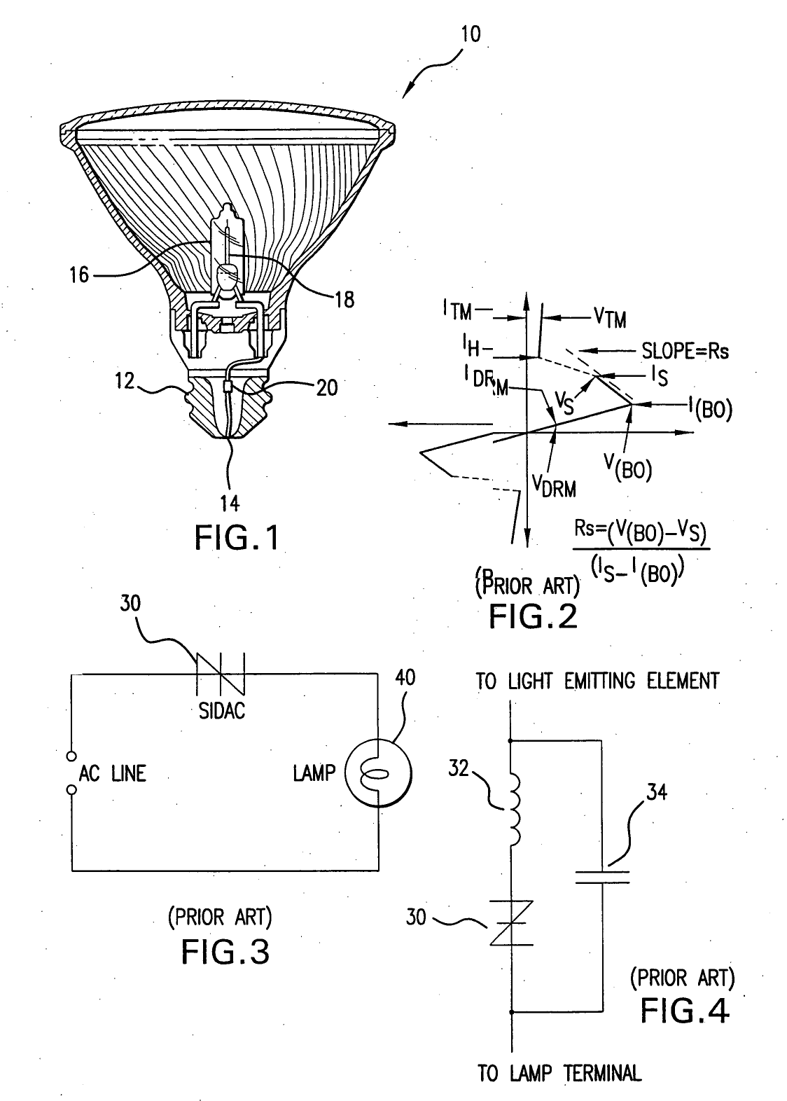

With reference to FIG. 1, a lamp 10 includes a base 12 that is arranged and adapted to fit into a lamp socket and having a lamp terminal 14 that is adapted to be connected to line (mains) voltage, a light-transmitting envelope 16 attached to the base 12 and housing a light emitting element 18 (an incandescent filament in the embodiment of FIG. 1), and a voltage conversion circuit 20 for converting a line voltage at the lamp terminal 14 to a lower operating voltage.

The voltage conversion circuit 20 is housed entirely within the base 12 (that is, entirely within the part of the lamp that is arranged and adapted to fit into a lamp socket such as shown in FIG. 1) and connected in series between the lamp terminal 14 and the light emitting element 18. The voltage conversion circuit 20 may be an integrated circuit in a suitable package as shown schematically in FIG. 1.

While FIG. 1 shows the voltage conversion circuit 20 in a parabolic aluminized reflector (PAR) halogen lamp, the voltage conversion circuit 20 may be used in any incandescent lamp when placed in series between the light emitting element (e.g., filament) and a connection (e.g., lamp terminal) to a line voltage.

The voltage conversion circuit 20 includes a silicon diode for alternating current (SIDAC). The SIDAC is known to those of skill in the art and its composition and operation are not the subject of the present invention. Briefly, the SIDAC is a high voltage bilateral trigger switch that extends the trigger capability to higher voltages and currents than attainable in previous devices. Being a bilateral device, the SIDAC will switch from a blocking state to a conducting state when the applied voltage of either polarity exceeds the breakover voltage V_{(BO)} as illustrated in FIG. 2 that shows idealized SIDAC characteristics. Once the input voltage exceeds V_{(BO)}, the device switches ON to the forward ON voltage V_{TM} (typically 1.1V) and can conduct as much as the specified repetitive peak ON-state current. The SIDAC switches through a negative resistance region to the low voltage ON-state and remains ON until the main terminal current is interrupted or drops below the holding current. The SIDAC lowers the RMS load voltage provided to the light emitting element of the lamp.

An explanation of the SIDAC is provided in ON Semiconductor Publication AND8015/D, “Long Life Incandescent Lamps Using SIDACs” by Ochoa, et al. (January 2000, Rev. 0) that is incorporated by reference. FIG. 2 is from this reference.

As explained in this ON Semiconductor publication, the SIDAC may be used with an incandescent lamp to lower the RMS load voltage and thereby increase lamp life. This reference suggests placing the SIDAC 30 in series with the lamp 40, as shown in FIG. 3, and mounted in the same place that the incandescent lamp is placed. However, there is no suggestion in this reference to place the SIDAC inside the lamp itself.

As shown in FIG. 1, the present invention houses the SIDAC entirely within the lamp base 12 that is arranged and adapted to fit into a lamp socket. The voltage conversion circuit 20 may consist solely of the SIDAC, where the SIDAC is a discrete component having an input directly connected to a first lead that is directly connected to the lamp terminal 14 and an output directly connected to a second lead that is directly connected to the light emitting element 18.

Since the voltage conversion circuit is not divided into separate parts, such as the high temperature tolerant and intolerant parts in the above-cited U.S. Pat. No. 6,445,133, the cost for the circuit is reduced and manufacturing complexity is reduced. Further, since the voltage conversion circuit is not in the stem and the size of the stem is not affected by the addition of the circuit within the lamp (see the extended stem in the above-cited U.S. Pat. No. 3,869,631), the complexity of the stem and the manufacturing cost thereof and the size of the lamp are reduced.

The addition of the SIDAC inside the lamp base as an integral component of the lamp, rather than separately external to the lamp, permits the use of optimized low-voltage filaments in lamps intended for use with standard sockets, thereby improving lamp beam performance, color temperature, efficacy, sag resistance, hot shock resistance, and vibration-induced flickering resistance.

As further explained in the ON Semiconductor publication, the fast turn-ON time of the SIDAC may generate radio frequency interference (RFI) that can be prevented by adding an RFI filter to the voltage conversion circuit. As shown in FIG. 4, the RFI filter may include an inductor 32 connected in series with the SIDAC 30 and a capacitor 34 connected in parallel with the SIDAC 30 and inductor 32. It is preferable that the inductor has a resonance frequency above an upper frequency of human hearing and below a lower frequency of an AM broadcast band.

While embodiments of the present invention have been described in the foregoing specification and drawings, it is to be understood that the present invention is defined by the following claims when read in light of the specification and drawings.

We claim:

1. An incandescent lamp comprising:
a base that includes a lamp terminal and that is arranged and adapted to fit into a lamp socket;
a light-transmitting envelope attached to said base and housing a light emitting element; and
a lamp voltage conversion circuit for converting a line voltage at said lamp terminal to an RMS load voltage that is lower than the line voltage and operates said light emitting element,
said voltage conversion circuit being housed entirely within said base and connected in series between said lamp terminal and said light emitting element, and
said voltage conversion circuit including a silicon diode for alternating current (SIDAC) that is a bilateral voltage triggered switch that receives the line voltage and provides the RMS load voltage.

2. The lamp of claim 1, wherein said voltage conversion circuit further comprises a radio frequency interference (RFI) filter.

3. The lamp of claim 2, where said RFI filter comprises an inductor connected in series with said SIDAC and a capacitor connected in parallel with said SIDAC and said inductor.

4. The lamp of claim 3, wherein said inductor has a resonance frequency above an upper frequency of human hearing and below a lower frequency of an AM broadcast band.

5. The lamp of claim 1, wherein said voltage conversion circuit consists of said SIDAC.

6. The lamp of claim 1, wherein said SIDAC is a discrete component having an input directly connected to a first lead that is directly connected to said lamp terminal and an output directly connected to a second lead that is directly connected to said light emitting element.
